(19) United States
(12) Patent Application Publication
(10) Pub. No.: US 2006/0101052 A1
(43) Pub. Date: May 11, 2006

(54) Method and system for sequencing and scheduling

(75) Inventors: Srinivas Netrakanti, Edmonton (CA); Brad Baynes, Spruce Grove (CA); Ashok Erramilli, Holmdel, NJ (US)

Correspondence Address: William L. Botjer, PO Box 478, Center Moriches, NY, 11934, US

(73) Assignee: NETAPS, INC., ABERDEEN, NJ (US)

(21) Appl. No.: 10/975,877

(22) Filed: Oct. 28, 2004

(51) Int. Cl. G06F 17/00; G06F 7/00

(52) U.S. Cl. 707/102

(57) ABSTRACT

A method and system as well as a computer program product for generating an optimized production sequence and schedule is provided. The method includes generation of a job object, a constraint object, a slot object and a parameters object that are used to generate the optimized production sequence and schedule. The system includes a configurable layer that stores the objects and a core product layer that generates the optimized sequence and schedule using the objects generated. The system may be used in conjunction with a variety of known optimization methodologies.

### BACKGROUND

The present invention relates generally to production sequencing and scheduling and specifically to a method and system for generating an optimized sequence and schedule for a set of jobs, given a capacity definition and a set of constraints.

Assembly lines are used in manufacturing plants when operations on a product must be performed in a sequence that is strictly ordered. However, efficient sequencing of units produced in an assembly line is a complex task as manufacturing and marketing constraints are numerous and constantly evolve to keep pace with dynamic manufacturing environments.

For production to flow at an optimum level in an assembly line, production schedules have to take into account the capacity definition of the assembly line and the constraints that affect it. Typical constraints include resource constraints such as shortages in labor and raw materials and capacity constraints around the capacity of production in a plant.

Recent technologies have enabled optimum production scheduling and sequencing to be performed by software systems. Some commonly employed optimization techniques include mathematical programming, dispatching rules, expert systems, neural networks, genetic algorithms, fuzzy logic, and inductive learning.

Current production scheduling systems, however, need reconfiguring of their optimization techniques each time they are installed for a new manufacturing environment. This presents problems for the installation of such a system. Besides, in today's dynamic conditions, constraints vary frequently in the middle of a production process depending on market conditions.

Accordingly, there is a need for an effective assembly line sequencing and scheduling solution that is customizable for any manufacturing environment. The customization scheme must be configurable, to enable application of the sequencing and scheduling solution to various manufacturing environments. Furthermore, as the constraints and requirements evolve, users must be able to easily modify the behavior of the existing features of the system to reflect the changes. The system should also be flexible to allow for new constraints to be easily incorporated.

### SUMMARY

Various embodiments of the present invention provide a method, system and computer program product to generate an optimized sequence and schedule for a job definition, a constraint definition, a parameters definition and a capacity definition. A job definition includes at least one job wherein each job comprises at least one unit to be produced. Each job is also described by at least one attribute that describes the units to be produced. A constraint definition comprises a limitation on the production of units. A parameters definition comprises a set of parameters that govern the behavior of the optimization methodology used to generate the optimized sequence and schedule. The optimized sequence and schedule is generated for a sequencing horizon, wherein the sequencing horizon defines the time duration for which the optimized sequence and schedule is generated. The system may be used in conjunction with a variety of known optimization methodologies.

The method to generate the optimized sequence and schedule, in accordance with an embodiment of the present invention, comprises generating generic objects in response to the above definitions and then using the generated generic objects in an optimization methodology that is used to generate the optimized sequence and schedule. The first step comprises generating at least one generic job object in response to a job definition. The generic job object provides the attributes of the job for use in the optimization methodology. The second step comprises generating at least one generic constraint object in response to a constraint definition. The generic constraint object uses the attributes of the job object for application of the constraint. The third step comprises generating at least one generic slot object in response to a capacity definition. The generic slot object represents a slot, wherein a slot represents a capacity for production of a unit of the job. The sequencing horizon is represented in the form of slots that divide the entire time duration of the sequencing horizon. The generic slot object enables the final optimized sequence and schedule to be represented in the form of slots throughout the sequencing horizon. The fifth step comprises generating a parameters object in response to the parameters definition. The parameters object is used to influence the optimization methodology according to the needs of the user.

Thereafter, a logic defined on the job definition is used to generate an initial solution. Finally, the four objects and the initial solution are used to generate the optimized sequence and schedule. This step also involves iterating the initial solution to improve the final sequence and schedule obtained.

Another embodiment of the present invention provides a system for generating the optimized sequence and schedule. The system comprises a configurable layer, which enables storing at least one generic job object, at least one generic slot object, at least one generic constraint object and a parameters object. Further, the system comprises a core product layer, which includes an optimization engine, wherein the optimization engine is used to generate the optimized sequence and schedule using the generic job object, the generic slot object, the generic constraint object and the parameters object.

### BRIEF DESCRIPTION OF THE DRAWINGS

Various embodiments of the present invention will hereinafter be described in conjunction with the appended drawings provided to illustrate and not to limit the present invention, wherein like designations denote like elements, and in which:

FIG. 1 is a flowchart depicting a method for generating an optimized sequence and schedule in accordance with an embodiment of the present invention.

FIG. 2 is a flowchart depicting a method for generating a generic job object in accordance with an embodiment of the present invention.

FIG. 3 is an exemplary graphical representation of a database storing a generic job object, a job definition and an attribute kit set, in accordance with an embodiment of the present invention.

FIG. 4 is a flowchart depicting a method for generating a generic constraint object in accordance with an embodiment of the present invention.

FIG. 5 is an exemplary graphical representation of a database storing a generic constraint object, a bin type and an attribute kit set, in accordance with an embodiment of the present invention.

FIG. 6 is a flow chart depicting a method for adding a new constraint type in accordance with an embodiment of the present invention.

FIG. 7 is a flowchart depicting a method for generating a generic slot object in accordance with an embodiment of the present invention.

FIG. 8 is an exemplary graphical representation of a database storing a capacity definition, a bin type and a generic slot object, in accordance with an embodiment of the present invention.

FIG. 9 is a schematic diagram of a system for generating an optimized sequence and schedule in accordance with an embodiment of the present invention.

### DETAILED DESCRIPTION

Definitions Of Terms Used In The Detailed Description

Job: A job comprises at least one unit to be produced. Each job is also described by at least one attribute that describes the units it comprises.

Job definition: A job definition comprises at least one job for production. A job definition also provides at least one attribute that describes each job.

Constraint definition: A constraint definition comprises a limitation on the production of units in an assembly line. A limitation may be applicable on the order of production of the units, the quantity of the units, or on the duration of production of the units.

Capacity definition: A capacity definition provides the maximum output that can be generated for a defined time period such as a day, week or any user defined period.

Parameters definition: A parameters definition comprises a set of parameters that govern the behavior of the optimization methodology used to generate the optimized sequence and schedule.

Input data: The job definition, the constraint definition, the capacity definition and the parameters definition are collectively termed as an input data.

Sequencing horizon: The sequencing horizon is the time duration for which an optimized sequence and schedule is generated.

Generic job object: A generic job object is a generic representation of the job definition that comprises at least one attribute of the job. The generic representation is in a format that allows processing by the optimization methodology used in conjunction with the present invention. The generic job object may also comprise at least one complex job attribute that is calculated using the attributes of the job.

Attribute kit: An attribute kit stores an attribute of the job by a generic representation of the attribute of the job. The generic representation allows the generic job object to store the attribute of the job for processing by the optimization methodology. Further, the attribute kit identifies a logic expression that enables calculation of a complex job attribute. The logic expression is also be used to apply the constraint on a particular value of the job attribute.

Generic constraint object: A generic constraint object is a generic representation of the constraint definition. The generic representation is in a format that allows processing by the optimization methodology used in conjunction with the present invention. The generic constraint object specifies a type of constraint that is applied on the production of a job. Further, the generic constraint object may include a time period and an attribute kit. The times period indicates the time for which the constraint is applied on the production of the job and an attribute kit.

Generic parameters object: A generic parameters object is a generic representation of the parameters definition that comprises at least one parameter influencing the optimization methodology. The generic representation is in a format that allows processing by the optimization methodology used in conjunction with the present invention.

Bin: A bin is a time unit that divides the sequencing horizon. Each bin is considered as a collection of a fixed number of slots. A bin can be embodied in several bin types such as a day, a week or a month.

Slot: A slot represents a capacity for production of a unit of a job.

Generic slot object: A generic slot object is a generic representation of a slot, which comprises at least one attribute describing the slot. The generic representation is in a format that allows processing by the optimization methodology used in conjunction with the present invention.

Configurable layer: A configurable layer configures input of the various input data according to a specific manufacturing environment. The configurable layers enable the various objects to be used by the optimization methodology used in conjunction with the present invention.

Optimization engine: An optimization engine includes algorithms that use an optimization methodology, using the at least one generic job object, at least one generic constraint object, at least one generic slot object and a parameters object to generate an optimized sequence and schedule

Core product layer: The core product layer enables the generation of the optimized sequence and schedule according to an optimization methodology in accordance with the present invention.

The present invention provides a method, a system and a computer program product for generating an optimized sequence and schedule for production, in response to a production requirement, or a set of jobs, in a given sequencing horizon, given a production capacity, and a set of constraints. In various embodiments of the present invention, the sequencing and scheduling is performed for manufacturing plants that use assembly lines for production.

In various embodiments, the production requirement is provided to the present invention in the form of at least one job, wherein each job includes at least one unit to be produced. Further, each job is described by at least one attribute that describes the units to be produced. The job and its attributes will hereinafter be referred to as job attributes. The job attributes considered by the present invention may vary from one application to another. For instance, an application of the present invention to a manufacturing plant for cars may consider, for example, job attributes such as the color, the model type and a proprietary code such as a Stock Keeping Unit (SKU) number for the cars to be produced. Another application of the present invention to a manufacturing plant for compressors may consider, for example, job attributes such as the type of compressor (reciprocating/rotary/scroll), the application of the compressor (air conditioning/refrigeration), cooling capacity, power and the like. In accordance with an embodiment of the invention, at least one job, wherein each job is described by a set of attributes is referred to as a job definition.

The present invention is configurable for use in various applications, having different sets of attributes for their units of production, and different constraints. Further, the present invention is configurable to accommodate changes in the set of attributes for the units of production, and in the constraints, for a particular application.

The production requirement may be provided to the present invention by means of a user interface that allows the user to specify the job attributes for the units to be produced. Alternatively, the production requirement may be provided by means of a database, or a plain text file, which specifies these attributes. It would be apparent to someone skilled in the art that various methods of providing the production requirement may be used, without deviating from the spirit and scope of the present invention.

Production schedules and sequences on assembly lines need to incorporate limitations on the production of units on an assembly line. A limitation on the production of the job will hereinafter be referred to as a constraint definition. A limitation may be applicable on the order of production of the units, the quantity of the units, or on the duration of production of the units.

The production capacity of a manufacturing plant indicates the highest, sustainable output that can be achieved with available plant capacity, labor force, equipment product specifications, and product mix. Accordingly, a capacity definition can be generated from the production capacity. In accordance with an embodiment of the present invention, the capacity definition provides the maximum production output that can be achieved for a defined time period such as a day, week or any user defined period.

The present invention may be used in conjunction with a variety of algorithms using known optimization methodologies. Many known optimization methodologies provide flexibility in their nature of optimization. Exemplary optimization methodologies used in accordance with an embodiment of the present invention include methods based on combinatorial optimization and search heuristics. Techniques such as simulated annealing, constraints technology, greedy heuristics and the like are some examples of optimization methods known in the art. Furthermore, these optimization methodologies may be customized using parameters to define the exact nature of optimization. In accordance with an embodiment of the present invention, a set of parameters governing the behavior of the optimization methodology used to generate the optimized sequence and schedule is provided to the present invention. The set of parameters is hereinafter referred to as a parameters definition.

The job definition, the constraint definition, the parameters definition and the capacity definition are hereinafter collectively referred to as input data. The present invention provides an interface between the optimization methodology and the input data, thereby isolating the optimization methodology from the input data. The interface maps the input data to a set of generic objects, which are used by the optimization methodology. Hence, only the interface needs to be configured for different manufacturing environments, while the same optimization methodology can be used.

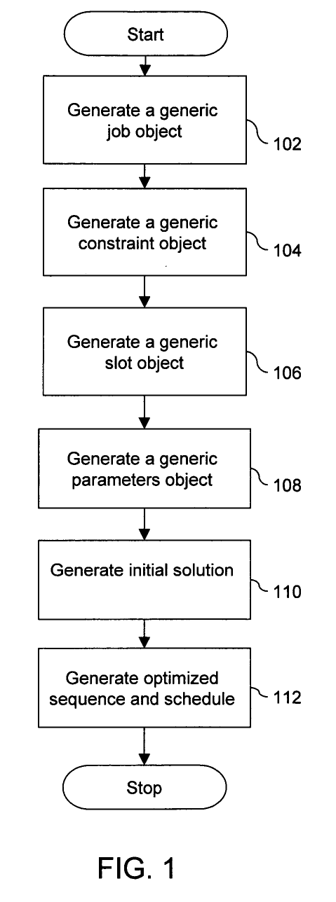

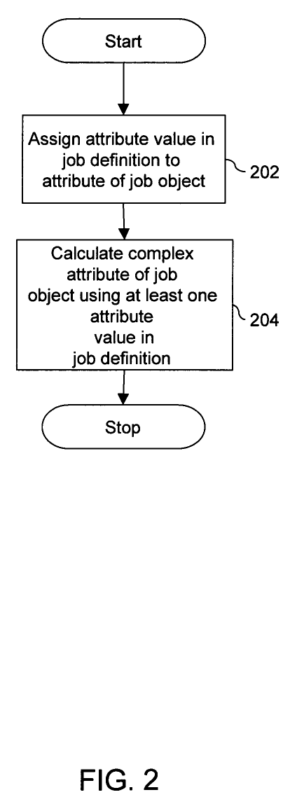

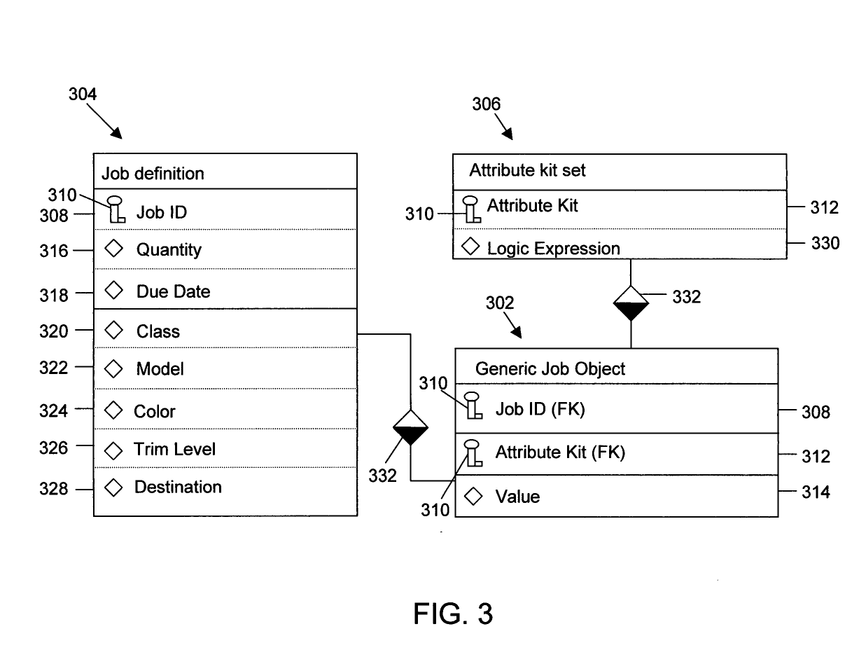

FIG. 1 is a flowchart depicting a method for generating an optimized sequence and schedule in accordance with an embodiment of the present invention. The method includes the generation of generic objects, wherein each object stores at least one attribute that describes the object. At step 102, at least one generic job object is generated in response to the job definition. The generic job object represents the job definition in a format that is independent of the manufacturing environment. This step is further explained in conjunction with FIG. 2, and an exemplary generic job object is described with reference to FIG. 3. The sequencing and scheduling is done using the attributes of the generic job object, which are used for evaluation of the constraints for the sequencing and scheduling. For example, a customer requirement for production of a particular set of cars may specify that black colored cars of a particular model be produced on a particular day of the week. Here, the model and the color of the car are job attributes that are used for application of the constraint.

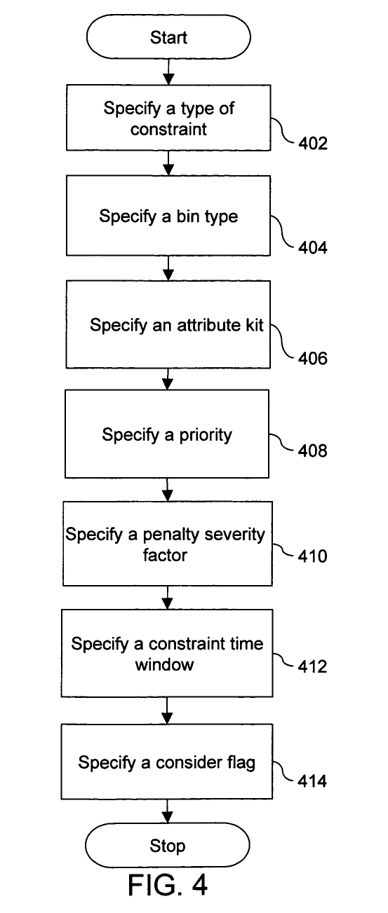

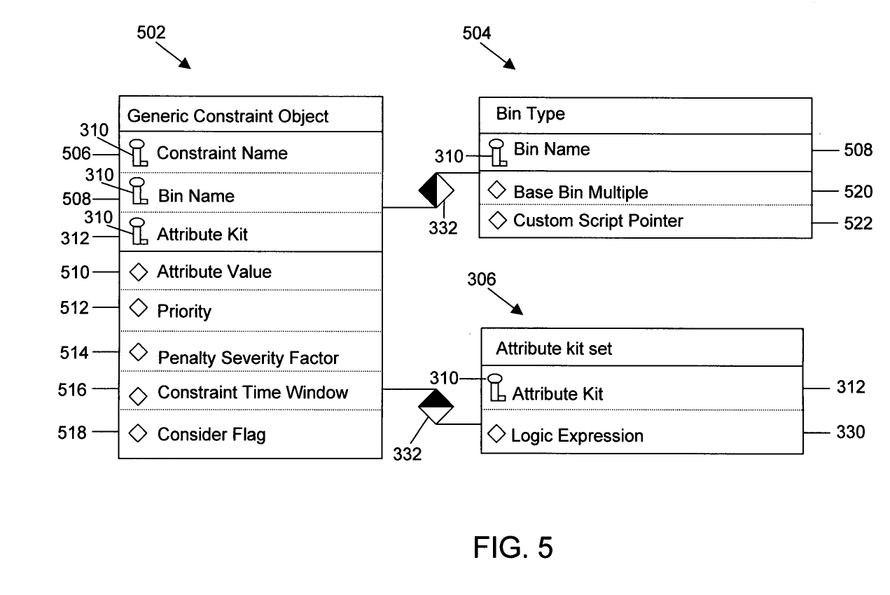

At step 104, at least one generic constraint object is generated in response to a constraint definition. The generic constraint object represents the constraint definition in in a format that is independent of the manufacturing environment. This step is further explained in conjunction with FIG. 4, and an exemplary generic constraint object is described with reference to FIG. 5. In accordance with an embodiment of the present invention, the generic constraint object includes the time period for which the constraint is applied on the production of the job. For example, a constraint definition could specify a constraint in a defined time period for every month in the sequencing horizon. An example of such a constraint definition could be as follows: ‘No more than five black cars can be produced in the first shift of Mondays and Wednesdays’. An attribute kit in the generic constraint object stores a job attribute, in order to identify the units of production to which the constraint is applicable. For example, if the job attribute were a color like black, it would indicate that the constraint is applicable to all units of a job that were black in color. The attribute kit also identifies a logic expression that enables the constraint to be applied using the job attribute. The logic expression performs functions and logical condition checks using any combination of attributes to further specify the application of a constraint. Consider the aforementioned example. If a particular machining application, like drilling, were to be applied only on the black colored cars, then a logic expression would be used to enable the same. An example of the logic expression using a job attribute is presented with reference to FIG. 3.

In various embodiments in accordance with an embodiment of the present invention, the generic constraint object may include various other attributes including a priority that defines the importance of the constraint relative to other constraints and a minimum and/or maximum production quantity that provides the upper and/or lower limit on the number of units to be produced in accordance with the constraint.

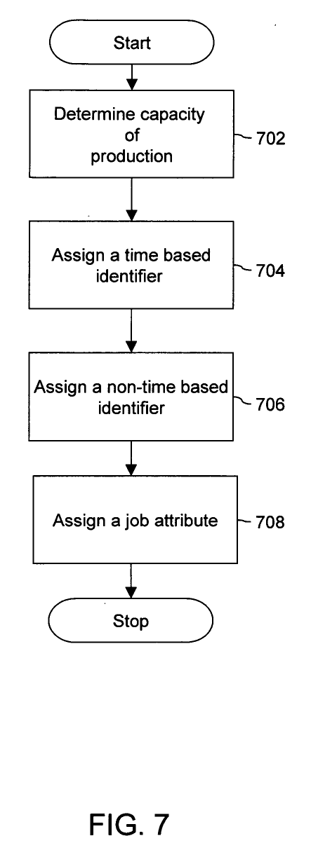

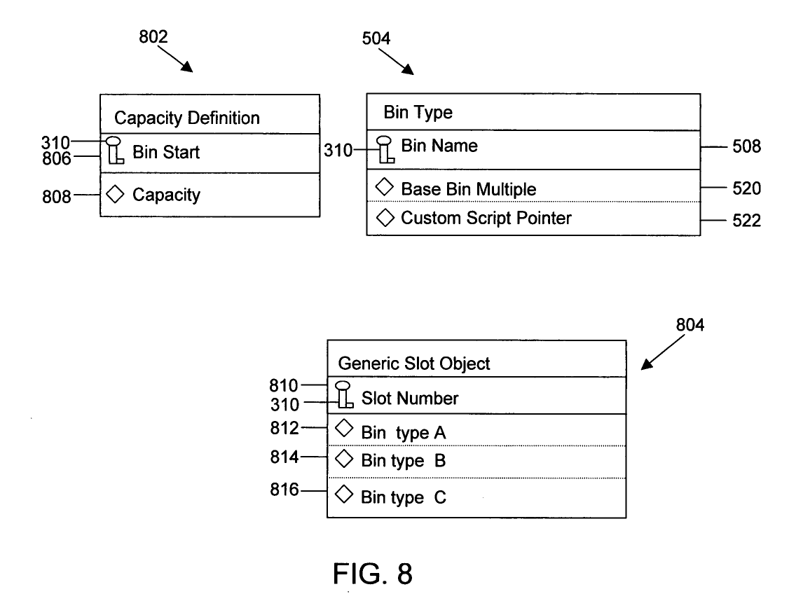

At step 106, at least one generic slot object is generated in response to a capacity definition. The generic slot object is represented in a format that is independent of the manufacturing environment. In accordance with an embodiment of the present invention, a slot represents the capacity to produce one unit of the job. For example, consider a manufacturing plant for cars that has a capacity of ten cars per working day. Thus, each working day for the plant is considered to have ten slots. At this step, the sequencing horizon is split into its constituent slots. For example, in the aforementioned manufacturing plant for cars, a sequencing horizon of one week, wherein the week comprises seven working days. Thus the total number of slots available would be 7*10 or 70 slots. In various embodiments, the present invention represents the sequencing horizon as a set of slots. Each slot is represented by a generic slot object for processing of the optimization methodology used in conjunction with the present invention. This step is further explained in conjunction with FIG. 7, and an exemplary generic slot object is described with reference to FIG. 8.

At step 108, a generic parameters object is generated in response to a parameters definition provided. The generic parameters object is generated by mapping the parameters in the parameters definition to attributes of the generic parameters object. The generic parameters object represents the parameters definition in a format that is independent of the manufacturing environment. The generic parameters object influences the method used to generate the optimized sequence and schedule. In an embodiment of the invention, the influencing is done by governing the attributes of a method used to generate the optimized sequence and schedule. Consider, for example a simulated annealing method used in a optimization methodology in conjunction with the present invention. Simulated annealing is a randomized local search method for finding near optimal solutions to combinatorial optimization problems. Simulated annealing operates by proposing a large number of random “moves”, where the rate of moving is governed by the parameters object and where a move can be any sort of change to a problem state. In accordance with an embodiment of the present invention, the problem state could comprise generating an optimized sequence and schedule given an input data. In various embodiments of the present invention, the generic parameters object also governs the trade-off between degree of optimization and the run time for optimization.

At step 110, an initial solution is generated using a predefined logic on the job definition. Various methods of generating an initial solution for sequencing and scheduling problems are known in the art. Some exemplary methods, suitable for use in conjunction with various embodiments of the present invention are described hereinafter. In an embodiment, an initial solution is generated by applying a heuristic to the job definition. A heuristic takes the input data and calculates a seemingly optimal solution based on a generic rule. In an embodiment of the present invention, the generic rule is a user defined rule. For example, a user may specify that the sequence and schedule according to the initial solution must process all jobs in the order of their respective due dates, irrespective of the attributes of these jobs. Alternatively, a user may specify that the sequence and schedule according to the initial solution must process all jobs in the order of the model of the units of production, irrespective of the due date of these jobs. In various embodiments, the initial solution is selected on the basis of the optimal sequence and schedule obtained from previous runs of the optimization algorithm. In an embodiment of the present invention, the initial solution is a random initial solution.

Using the initial solution generated, the at least one job object, the at least one slot object, the at least one constraint object and the parameters object, the final optimized sequence and schedule is generated at step 112. This generation of the final sequence and schedule includes iteratively optimizing the initial solution to obtain the final sequence and schedule. Various optimization methodologies for such iteration, such as simulated annealing, constraints technology and greedy heuristics, are known in the art. It will be apparent to some one skilled in the art that any optimization methodology can be used in conjunction with the present invention without deviating from the spirit and scope of the present invention.

It should be noted that the methodology used for optimization is independent of the manufacturing environment that the present invention is applied to. In addition to the optimization techniques listed previously, any other method known in the art can be employed for the generation of the optimized sequence and schedule. Moreover, the generic objects discussed above can enable any input data from any manufacturing environment to be used for generation of the optimized sequence and schedule using the same underlying optimization methodology.

FIG. 2 is a flowchart depicting a method for generating a generic job object in accordance with an embodiment of the present invention. This method is directed towards mapping the information contained in the job definition to a generic job object, which is used by the optimization methodology for the sequencing and scheduling. At step 202, at least one attribute value of the job definition is assigned to an attribute of the generic job object through a simple one to one data mapping technique. At step 204, a complex job attribute of the job object is calculated using at least one attribute value in the job definition. This complex job attribute is calculated to enable increased customization for the optimization methodology. For example, consider a case wherein an optimized production sequence and schedule is to be produced for a set of cars. A constraint for the example may specify that dark cars be produced in the first week of a production cycle. Here, the constraint does not specify a particular color. Therefore, a complex job attribute is created that defines whether a car is dark or light colored. To calculate the same, a user defined function is used to compute the complex job attribute using a color specified for the car. A sample user defined logic may is as follows.
If (color==blue ∥red ∥black) complexjobattributevalue==“dark”;
else outputcomplexjobattribute==“light”

The logic in the above example defines a dark complex job attribute if the color of a job is blue, red or black and defines a light complex job attribute for any other color. In various embodiments of the present invention, the calculation is performed by a formula or algorithm specified by the user.

However, it is not necessary for the generic job object to only include attributes that have been arrived at by calculation. The job attributes can simply be the assigned values of the job definition obtained by the one to one data mapping technique.

FIG. 3 presents an exemplary graphical representation of a database storing a generic job object 302, a job definition 304 and an attribute kit set 306, in accordance with an embodiment of the present invention. Job definition 304 stores the fields that describe a job including a job id 308, a quantity 316, a due date 318, a class 320, a model 322, a color 324, a trim level 326 and a destination 328. Job id 308 identifies a job by a unique identifier such as a model number or a name. Quantity 316 stores the number of units defined in the job. Due date 318 stores the date at which the job is due for production. Class 320 stores a predefined class under which the job can be classified. A class could be a categorization of a job based on a predefined criterion. For instance, a job having a machining time of 2 minutes can be grouped in a ‘class A’, while those having a machining time of 5 minutes could be grouped in a ‘class B’. Model 322 stores the model of the job, which, for instance, could be the year of production or a proprietary code. Trim level 326 denotes the level of optional features being included in the job and destination 328 denotes the destination to which the job must be shipped to after production. It will be apparent to a person skilled in the art that the fields stored in job definition 304 will be unique to the manufacturing environment that the production sequence and schedule is being generated for. For example, in the case of a manufacturing plant for production of compressors, the fields may comprise the power input to the compressor, the tonnage that the compressor offers, the model of the compressor and the like.

Attribute kit set 306 stores at least one attribute kit 312. Attribute kit 312 stores a job attribute obtained from the job definition. Further, attribute kit 312 identifies a logic expression 330 used for the computation of a complex job attribute. Logic expression 330 is a user defined logic that uses at least one attribute value in job definition 304 to generate a value 314 in generic job object 302. Consider the following logic expression that uses raw fields (job attributes) supplied in a sales order data Job definition) to determine a complex job attribute.
if ($MODEL.substring(0,2)==“AB”∥$MODEL.substring(0,1)==“L”) destination =“Q1”;
else destination=“Q”+$CLASS.substring(3,1);
if (destination==“Q4”∥destination==“Q7”) return Value=“Yes”;
else return Value=“No”;

This sample expression first calculates an intermediate value ‘destination’ based on the MODEL and CLASS attribute values of a selected job. MODEL and CLASS may be used in conjunction with the explanation given above for model 322 and class 320 used in job definition 304. The expression determines the value based on this ‘destination’ value using a conditional logic. According to the expression, if the model is AB or L, the destination returned is Q1, else it is another computed value. Alternatively, if the destination is either of Q4 or Q7, the value returned is Yes, else it is No.

Generic job object 302 stores job id 308, attribute kit 312 and value 314. Key 310 and abbreviation FK denotes that job id 308 is a foreign key that has access to primary key job id 308 in job definition 304. A foreign key is an attribute that can uniquely identify a record in another table. A foreign key is the primary key of another table. A primary key is An attribute in a table that uniquely identifies rows of that table. Foreign key-primary key relationships define a relational join. Accordingly, attribute kit 312 stored in generic job object 302 is a foreign key that has access to primary key attribute kit 312 stored in attribute kit set 306. Value 314 stores the assigned or calculated complex job attribute as the case may be. For example, in the logic function used above, value 314 stores the complex job attribute ‘Yes’ or ‘No’ based on the computation carried out. Alternatively, value 314 simply stores an assigned value in case no logic function has been used.

Symbol 332 denotes a ‘many-to-one’ relation between the tables it links. The dark half of symbol 332 represents the ‘many’ table, while the light half of symbol 332 represents the ‘one’ table.

FIG. 4 is a flowchart depicting a method for generating a generic constraint object in accordance with an embodiment of the present invention. At step 402, a type of constraint is specified. The type of constraint specifies the nature of the constraint being applied. For instance, a ‘changeover’ constraint puts a constraint on the order of production. An example of the same is a constraint that specifies that a blue car not succeed a red car for production in the assembly line. A ‘feature capacity’ constraint puts a limit on the number of units that can be produced in a specified time period while a ‘distribution constraint’ allows distribution by an attribute of the job. At step 404, a bin type to which the constraint applies is specified. A bin is a time unit that logically divides the sequencing horizon. These bins can be defined using any standard time unit (e.g. 15 bins of 24 hours each or 30 bins of 12 hours each) where each bin is of the same size. The present invention also allows multiple standard time unit bin types to be considered concurrently. This is achieved by identifying a single base bin size that is a common denominator for each bin type to be used. In this case, only the capacity of the base bin needs to be provided to define the capacity of the entire sequencing horizon. For example, specifying the capacity of a 12 hour base bin inherently also defines the capacity of all larger bin types that are a multiple of this time period such as days and weeks. Therefore, a bin can be embodied in several bin types depending on the time duration. At step 406, at least one attribute kit to which the constraint type applies is specified. A constraint, for instance, may apply on a blue colored car, in which case the attribute kit specified would be the color of the car. At step 408, a priority is specified for the constraint. The priority defines the importance of one constraint type relative to another constraint type. For instance, a changeover constraint specifying that a black car not succeed a white car may be more important than a feature capacity constraint that specifies an upper limit on the number of white cars being produced in a day. Accordingly, the changeover constraint will have a higher priority than the capacity constraint. At step 410, a penalty severity factor is specified that is used to parametrically relate the cost incurred upon a constraint not being satisfied to the extent of violation of the constraint. The penalty severity factor is used, in conjunction with the priority, to evaluate the cost of each violation of the constraint. A higher penalty severity factor results in a relatively higher cost being assigned to larger violations of the constraint in the sequence and schedule. For example, with a penalty severity factor of zero, there is an identical cost to assigning 1100 or 1200 cars to a week, while with a penalty severity factor of 2, the cost of assigning 1200 cars to a week will significantly exceed the cost of assigning 1100 cars to the week. At step 412, a constraint time window is specified that indicates the time duration during which the constraint is active. For example, in case of a power outage occurring for two hours on a particular day, a constraint specifying that production would not be on for two hours would have a constraint time window for those two hours. At step 414, a consider flag is specified that allows disabling of the constraint when required. A user specification may specify that the constraint not apply to more than 10 units in a job, in which case the consider flag would disable the constraint after production of 10 units. In various embodiments of the present invention, a minimum and a maximum quantity of units that the constraint would apply to is also specified.

FIG. 5 illustrates an exemplary database for storing a generic constraint object 502, a bin type 504 and attribute kit set 306, in accordance with an embodiment of the present invention. Generic constraint object 502 stores foreign key constraint name 506, foreign key bin name 508 and foreign key attribute kit 312. Additionally, generic constraint object 502 also stores an attribute value 510, a priority 512, a penalty severity factor 514, a constraint time window 516 and a consider flag 518.

In accordance with an embodiment of the present invention, generic constraint object 502 is a constraint type as described with reference to FIG. 4. Constraint name 506 is a primary key that stores the name of the constraint, which is any proprietary name given by a user. Foreign key bin name 508 stores the name of a bin type 504 that is used to divide the sequencing horizon.

Foreign key bin name 508 in generic constraint object 502 is described further in bin type 504. Bin type 504 stores primary key bin name 508. A base bin multiple 520 relates bin type 504 to the base bin defined within the system. Since, the base bin size is a common denominator of all defined time-based bin types, base bin multiple 520 is bin type 504 divided by the base bin. If a base bin consists of 12 hours, a day bin type has base bin multiple 520 of two while a week bin type has base bin multiple 520 of 14. A custom script pointer 522 points bin type 504 to a custom logic when the base bin cannot be defined by a fixed duration of time, such as a day or 12 hours. Examples of bin types requiring custom logic are variable length shifts and production cycles, where each cycle is a variable number of production units.

With reference to generic constraint object 502, attribute value 510 stores the attribute value that the constraint applies to. Attribute value 510 stores a value of attribute kit 312 and logic expression 330 enables application of the constraint to that value. For example, consider attribute kit 312 storing job attribute color and attribute value 510 storing a value ‘Blue’. Logic expression 330 would enable the constraint to be applied on blue colored units of a particular job. Further, generic constraint object 502 stores priority 512, penalty severity factor 514, constraint time window 516 and consider flag 518 as described with reference to FIG. 4.

Given below are three examples of generic constraint objects using the representation shown in FIG. 5.

### EXAMPLE 1

### Changeover Constraint Type

| Constraint Property | Value |
|---|---|
| Constraint name | COLOR-BW |
| Attribute kit | EXTERIOR-COLOR |
| Attribute value | BLACK |
| Attribute kit 2 | EXTERIOR-COLOR |
| Attribute value 2 | WHITE |
| Priority | 10 |
| Consider flag | Yes |
| Changeover time | 0 |

Example 1 is an exemplary changeover constraint type. The constraint is named COLOR-BW, a terms that serves as an identifier for the constraint. An attribute kit EXTERIOR-COLOR is applied on attribute value BLACK and to attribute value WHITE. A user defined logic specifies that if a black colored car is produced, then a white car cannot follow it. A priority of 10 is assigned on this constraint. The priority may imply the constraint is more important than others based on a user defined scale. A changeover constraint is violated when in the sequence or schedule when a black colored car is immediately followed by a white colored car. Additionally, a consider flag is used for denoting that the constraint is active and not disabled. Furthermore, a changeover time from one car to another in the production line is assigned a value of zero.

### EXAMPLE 2

### Feature Capacity Constraint Type

| Constraint Property | Value |
|---|---|
| Constraint name | CAPACITY-COLOR-RED |
| Attribute kit | EXTERIOR-COLOR |
| Attribute value | RED |
| Minimum production | 0 |
| quantity | |
| Maximum production | 1000 |
| quantity | |
| Bin | WEEK |
| Priority | 5 |
| Penalty severity factor | 2 |
| Consider flag | Yes |
| Quantity type | JOB-QUANTITY |
| Changeover time | 0 |

Example 2 is an exemplary feature capacity constraint type. An attribute kit EXTERIOR-COLOR is applied to an attribute value RED. Further, a minimum production quantity of zero and a maximum production quantity of 1000 is specified. A bin in this case is a week. Additionally, a priority of five is assigned to the constraint, denoting that the constraint may have a medium priority based on a user defined scale. A quantity type JOB-QUANTITY specifies the logic to be used. Here, the logic specifies that a maximum of 1000 red cars can be produced in a week. Additionally, a penalty factor of two is assigned which implies greater violations are more severely penalized.

### EXAMPLE 3

### Distribution Constraint Type

| Constraint Property | Value |
|---|---|
| Constraint name | DISTRIBUTE-MODEL |
| Attribute kit | MODEL |
| Attribute value | |
| Bin | DATE |
| Priority | 2 |
| Penalty severity factor | 2 |
| Quantity type | JOB-QUANTITY |
| Tolerance plus quantity | 10 |
| Tolerance minus quantity | 0 |
| Preprocess | Yes |
| Consider flag | Yes |

Example 3 is an exemplary distribution constraint type. A constraint name DISTRIBUTE-MODEL is given and an attribute kit MODEL is applied to all jobs irrespective of any attribute. This is denoted by a blank against the field ‘attribute value’. The quantity type JOB-QUANTITY specifies a user defined logic to be used. The logic specifies that jobs of all models should be distributed evenly. The fields ‘tolerance plus quantity’ and ‘tolerance minus quantity’ specify that the production of the job must incorporate all tolerances specified and ensure a high quality. A preprocess value specifies that a target value must be calculated. For certain constraint types, like a distribution constraint type, the occurrence of a violation of the constraint and the extent thereof is determined by comparing the observed value in the sequence and schedule with a target value. Preprocessing is the process of automatically computing the target value by examining the jobs definition. Additionally, a consider flag is used to denote that the constraint is active.

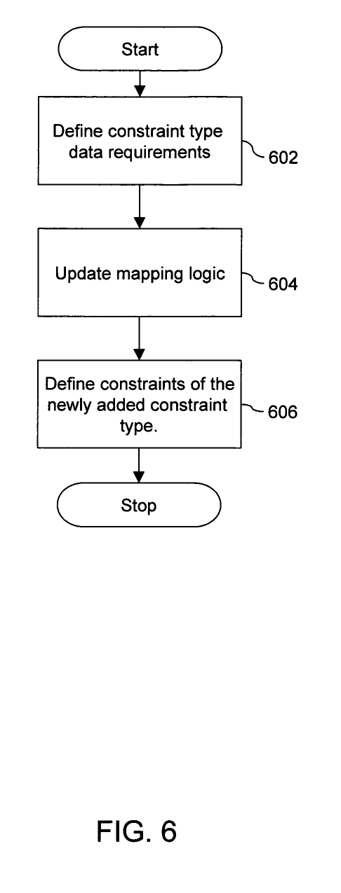

FIG. 6 is a flow chart depicting a method for adding a new constraint type in accordance with an embodiment of the present invention. At step 602, data requirements of the new constraint type are defined. For example, consider a case wherein a changeover constraint is to be applied on a production sequence, wherein the sequence had to change not in case of a color, but in case of a particular model of a car. An exemplary constraint of this kind would specify that a model TX 30 not succeed a model TX 28. In such an event, attribute kit 312 in generic constraint object 502 would be a ‘model’ and attribute value 510 would be the model type on which the constraint is applied to. At step 604, the logic required to account for the new data is updated, implying that logic expression 330 would need to be updated in such an event. In accordance with an embodiment of the present invention, this step is performed manually by technical resources. Also, the logic change required for performing this step would be apparent to a person skilled in the art. The logic thus updated is mapped to generic constraint object 502 for application of the constraint to attribute value 510. Thereafter, at step 606, constraints of the newly added constraint type are defined by the user since the new constraint would have appropriately different values for fields priority 512, penalty severity factor 514, constraint time window 516 and consider flag 518.

FIG. 7 is a flowchart depicting a method for generating a generic slot object in accordance with an embodiment of the present invention. At step 702, a capacity of production is entered for a time based base bin. For example, the capacity for ‘day bin 1’ could be entered as 30 units while the capacity for day bin 2 could be entered as 25. This enables the determination of all time based bin types defined since the base bin is a common denominator. As described earlier, if a bin type is a week, the capacity for each week is computed as the sum of the daily capacities within that week. The overall capacity is computed as the sum of all daily capacities within the sequencing horizon. Based on this information, a specified number of slots is determined for each bin. The generation of slots also allows custom bin types to be defined in the system. A user can create a bin type, name it using any proprietary terminology (e.g. shift, cycle and the like) and use a logic to assign each slot to a relevant bin. For example, the first 75% of each day's capacity might be assigned to a single shift with the remaining 25% being assigned to a separate shift. In effect, if a day bin comprised 100 slots, the first 75 could be assigned to a one shift, while the remaining 25 to another. Once this step is performed, a generic slot object that defines a slot is assigned at least one time based identifier at step 704. For example, if a slot lies in the first hour of the day, the generic slot object may be assigned a value ‘Hour 1’ and ‘Day 1’ to identify it. Additionally, the generic slot object is given at least one non-time based identifier at step 706. In accordance with an embodiment of the present invention, the non-time based identifier could be a value related to the slot's cycle of production. If a slot lies in the second cycle of the sequencing horizon, a value like cycle 2 is assigned to the generic slot object. At step 708, the generic slot object is assigned at least one job attribute to identify the subset of jobs that can be scheduled to the slot. For instance, if a black colored car is produced in the slot assigned ‘Hour 1’ and ‘Day 1’, an additional attribute ‘black’ is assigned to the generic slot object to further identify it. In various embodiments of the present invention, the generic slot object stores at least one time-based identifier and/or at least one non-time based identifier.

FIG. 8 is an exemplary graphical representation of a database storing a capacity definition 802, bin type 504 and a generic slot object 804, in accordance with an embodiment of the present invention. Capacity definition 802 stores a primary key Bin start 806 and a capacity 808. Bin start 806 stores a time-based field to indicate the start of each bin according to the base bin definition. For example, if the first day of production comprises two bins of 12 hours each, the Bin start values for these two bins would be 12 hours apart. Capacity 808 stores the capacity of a base bin defined within the sequencing horizon. Given this base bin capacity, the overall capacity can be calculated, as the base bin is a common denominator for all bins in the sequencing horizon.

Capacity definition 802 and bin type 504 provide information for determination of slots within the bins dividing the sequencing horizon. For example, consider a case when bin type 504 is a week having a base bin defined as a day. Capacity 808 defines the capacity for the day, which enables the determination of the capacity for the week. Thereafter, slots can accordingly be determined for the entire week and appropriate slot objects can be generated based on this information.

In an embodiment in accordance with the present invention, generic slot object 804 stores a primary key slot number 810, a bin type A 812, a bin type B 814 and a bin type C 816. Slot number 810 stores a user defined number for uniquely identifying the slot. Bin type A 812, bin type B 814 and bin type C 816 store the bins to which the slot belongs based on each bin type definition. For example, bin type A could be a month in the sequencing horizon to which the slot belongs, bin type B could be a week in that particular month, while bin type C could be a day in that week. The three bin types are used for increasing the identifiers for slot object 804 in order to better identify the slot.

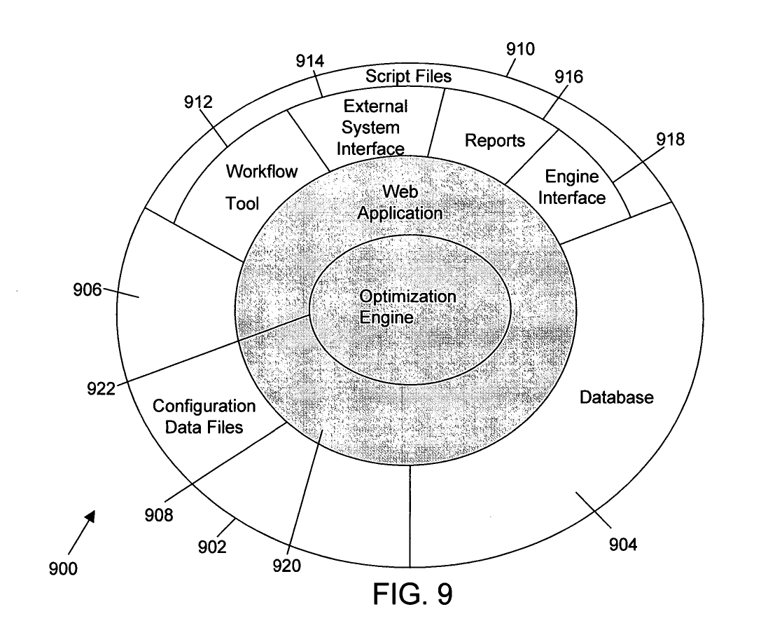

FIG. 9 is a schematic representation of a system 900 used for generating the optimized sequence and schedule in accordance with an embodiment of the present invention. In various embodiments, system 900 implements the method as described with reference to FIG. 1.

System 900 comprises a configurable layer 902 and a core product layer 908. FIG. 1 shows configurable layer 902 as unshaded elements, and core product layer 908 as shaded elements. Configurable layer 902 can be configured for application to various manufacturing environments, while core product layer 908 does not require any change or customization for the various manufacturing environments. As a result, the present invention can be used for various manufacturing environments with customization only in configurable layer 902. In accordance with an embodiment of the present invention, configurable layer 902 and core product layer 908 is stored on a server.

Configurable layer 902 comprises a database 904 and configuration data files 906. Database 904 stores job definition 304, capacity definition 802, the constraint definition, and the parameters definition. A data dictionary stored in database 904 configures entry of input data into the aforementioned definitions. In accordance with an embodiment of the present invention, parameters defined in the data dictionary allow configuration of database tables to store the input data on database 904. Database tables also store generic job object 302, generic constraint object 502, generic slot object 804 and the parameters object. The configuration allowed by the data dictionary includes addition, deletion and editing of database tables and their structures. In addition the data dictionary also allows configuration of complex schema that involve multiple database tables related to one another through a common unique identifier. The data dictionary links the various database tables through common unique identifiers such as the foreign keys used in generic job object 302 and generic constraint object 502 to access fields in related database tables.

Configuration data files 906 comprise script files 910, which are executed using a scripting engine embedded within core product layer 908. Script files 910 are composed of commands from any scripting language, such as VBScript, JavaScript, Jscript, perlScript, Python and the like.

Script files 910 configure workflow tool 912 to system 900. Workflow tool 912 enable workflow such as entering and viewing the input data, invoking optimization to generate the optimized sequence and schedule, viewing and modifying the generated sequence and schedule and the like. Further, workflow tool 912 also allows the flow of work between various system elements to be defined and tracked. The importing of input data to the system and exporting of the generated sequence and schedule is performed through external system interface 914. In accordance with an embodiment of the present invention, external system interface 914 enables a thin client to access configurable layer 902.

Script files 910 also enable external system interface 914 to interact with core product layer 908. The interaction is enabled by an application program interface (API) provided by external system interface 914. The API includes the programming functions and routines that provide access to core product layer 908. Script files 910 handle a variety of application program interfaces (API) including Open DataBase Connectivity (ODBC), web services, Computer Gateway Interface (CGI) and servlets. Script files 910 also generate reports 916 which are used to view the input data and the optimized sequence and schedule. Reports 916 can be configured to be in any computer readable format such as an excel sheet or a word document and are used for decision support of system 900. Engine interface 918 enables generation of the various objects including generic job object 302, generic constraint object 502, generic slot object 804 and the generic parameters object. Script files 910 generate generic job object 302 by the method described with reference to FIG. 2. Script files 910 enable the mapping of job attributes in job definition 304 to attributes in generic job object 302. Script files 910 also perform the calculation of complex job attributes used in generic job object 302. Further, script files 910 enable generation of generic constraint object 502 from the constraint definition as per the method described in FIG. 4 and the generation of the generic slot object as per the method described in FIG. 7. Script files 910 also generate the generic parameters object by enabling a one to one mapping with the attribute values of the parameters definition with the attributes in the generic parameters object. Additionally, any logic used in the method to generate the optimized sequence and schedule is defined using script files 910. For instance, the predefined logic used on the job definition to generate the initial solution is defined using script files 910.

Configuration data files 906 also comprise input files that are used to generated the input data. For example, if the form of input to system 900 is in the form of sales orders, wherein the sales orders comprises data related to at least one job, then the input files will be used to alter the format and structure of the sales order file to make it suitable for generation of job definition 304. Input files also provide support data required for custom workflow. For example, an exemplary workflow may comprise comparing the actual sales of a manufacturing plant with the sales forecasts provided. In such an event, input files will be used to provide any relevant data comprised in database 904 to enable the comparison.

Core product layer 908 comprises a web application 920 and an optimization engine 922. Web application 920 stores all business logic required to process the input data in database 904. The business logic includes the rules associated with the input data stored in database 904 that typically encode business policies. For example, the business logic would be used to add additional inventory cost for units in a job that are stored longer than their defined storage period. Furthermore, web application 920 includes a graphical user interface (GUI) that facilitates access to configurable layer 902 and core product layer 908. Further, the database tables are configured via the GUI. Navigation elements such as menus displayed to the user are also configured via the GUI. The navigation elements and the display labels defined for each table allow the use of any preferred terminology with the GUI. Additionally, validations are defined for each field in a table to control the data entered into system 900 via the GUI. For example, if a job definition describes only three colors for a particular car, validations will be created for the three colors to increase the ease of entering data. The GUI also provides triggers that can be defined for each table to invoke additional data processing when the users add, edit or delete data in a database table. For example, the GUI provides pointers to a user when attributes for a job definition are being entered. Such pointers could be in the form of questions to the user asking the user to provide data necessary for computing a complex job attribute for instance. Optimization engine 922 includes the optimization algorithms that use at least one generic job object 302, at least one generic constraint object 502, at least one generic slot object 804 and the parameters object to generate the optimized sequence and schedule. Script files 910 enable at least one generic job object 302, at least one generic constraint object 502, at least one generic slot object 804 and the generic parameters object to be fed into optimization engine 922 for generation of the optimized sequence and schedule, which can be viewed through the GUI stored in web application 920. In various embodiments of the present invention, the optimized sequence and schedule can be represented in the form of a generic solution object that facilitates examination, analysis and manipulation of the optimized sequence and schedule. For example, the final optimized sequence and schedule can be in the form of an interactive output that allows manipulation to take into account modifications to the input data. In various embodiments of the present invention, the manipulation allows multiple tasks to be executed in the optimized sequence and schedule. These tasks include but are not limited to, exchanging a pair of jobs in the optimized sequence and schedule, moving at least one job in the sequence to another position and adding or deleting a job based on any user requirements. The method also allows generation of a changed total cost resulting from any manipulation carried out. Further, it allows the user of system 900 to accept or reject the manipulations and to roll back previously accepted manipulations.

The method and system according to the present invention offers many advantages. In accordance with an embodiment of the present invention, configurable layer 902 is customizable for a specific manufacturing environment since it is defined external to core product layer 908. The optimization is completely parametric which ensures greater accuracy of the optimization. Moreover, the system provides an easy and user-friendly interface for customizing configurable layer 902 according to a specific manufacturing environment. Furthermore, system 900 provides flexibility in adding new constraints when required. Additionally, in accordance with an embodiment of the present invention, system 900 is used in a web-based model in which the system 900 resides on the server with web pages being served to the browser clients in response to user requests. System 900 is also extensible to a client server model. Besides if the client server model is applied to a network, the client/server model provides a convenient way to interconnect programs that are distributed efficiently across different locations.

System 900 may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device that enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention as described in the claims.

What is claimed is:

1. A method for obtaining an optimized sequence and schedule for production of at least one job in a sequencing horizon, the sequencing horizon defining the time duration for which the optimized sequence and schedule is generated, given at least one constraint and a capacity definition, the capacity definition defining the number of units that can be produced in a defined time period, the job comprising at least one unit to be produced, the method comprising the steps of:
a. generating at least one generic job object in response to a job definition, the job definition comprising at least one attribute describing the job;
b. generating at least one generic constraint object in response to a constraint definition, the constraint definition comprising a limitation on the production of the job;
c. generating at least one generic slot object in the sequencing horizon using the capacity definition, the slot object comprising at least one attribute uniquely identifying a slot, the slot comprising a capacity for production of a unit of the job;
d. generating a generic parameters object in response to sequencing and scheduling parameters, the parameters definition comprising at least one parameter influencing the method of optimization used for generating the optimized sequence and schedule;
e. generating an initial solution using a predefined logic; and
f. generating the optimized sequence and schedule by an optimization algorithm, the optimization algorithm using at least one of the generated generic job object, at least one of the generated generic slot object, at least one of the generated generic constraint object, the generated generic parameters object and the generated initial solution.

2. The method according to claim 1, wherein the step of generating the generic job object in response to a job definition comprises at least one of the steps of:
a. assigning at least one attribute value in the job definition to at least one attribute of the generic job object; and
b. calculating at least one complex job attribute of the generic job object using at least one attribute value in the job definition.

3. The method according to claim 1, wherein the step of generating the generic constraint object comprises the steps of:
a. specifying a constraint type;
b. specifying a bin type, wherein the bin type is a time unit in the sequencing horizon;
c. specifying at least one attribute kit, the attribute kit indicating the attribute of a job to which the constraint is applicable;
d. specifying a priority, the priority defining the importance of the constraint relative to other constraints;
e. specifying a penalty severity factor, the penalty severity factor parametrically relating the cost incurred upon a constraint not being satisfied to the extent of violation of the constraint;
f. specifying a constraint time window indicative of the time duration during which the constraint is active; and
g. specifying a consider flag for allowing disabling of the constraint.

4. The method according to claim 1, wherein the step of generating the generic constraint object comprises specifying constraint specific properties associated with a generic constraint object.

5. The method according to claim 4, wherein the step of specifying the constraint specific properties comprises at least one of the steps of:
a. specifying a minimum production quantity;
b. specifying a maximum production quantity; and
c. specifying an attribute kit value against each attribute kit in the generic constraint object.

6. The method according to claim 1, wherein the step of generating the generic slot object comprises assigning a slot identifier for uniquely identifying the slot.

7. The method according to claim 1, wherein the step of generating the generic slot object comprises at least one of the steps of:
a. determining the capacity of production;
b. assigning a time-based bin identifier for identifying a bin to which the slot belongs;
c. assigning a non-time-based bin identifier for identifying a bin to which the slot belongs; and
d. assigning a job attribute associated with the slot.

8. The method according to claim 1, wherein the step of generating the initial solution in response to a predefined logic comprises generating a random initial solution.

9. The method according to claim 1, wherein the step of generating the initial solution in response to a predefined logic comprises generating an initial solution in response to a logic defined on the job definition;

10. The method according to claim 1, wherein the optimization algorithm uses at least one of a combinatorial optimization method and a search heuristics method for generation of the optimized sequence and schedule.

11. The method according to claim 1, wherein the optimization algorithm uses an optimization methodology from a group consisting of simulated annealing, constraints technology and greedy heuristics.

12. The method according to claim 1, further comprising representing the optimized sequence and schedule in the form of a generic solution object to facilitate examination, analysis and manipulation of the optimized sequence and schedule.

13. The method according to claim 12, further comprising the step of manipulating the optimized sequence and schedule, the manipulating comprising at least one of the steps of:
a. exchanging a pair of jobs in the optimized sequence and schedule;
b. moving one or more jobs in the optimized sequence and schedule to another position;
c. adding a job to the optimized sequence and schedule; and
d. deleting a job from the optimized sequence and schedule.

14. The method according to claim 13, wherein the manipulating step further comprises at least one of the steps of:
a. providing a changed total cost resulting from the manipulations;
b. allowing the user to accept or reject the manipulations; and
c. allowing the user to rollback previously accepted manipulations.

15. A system for obtaining an optimized sequence and schedule for production of at least one job in a sequencing horizon, the sequencing horizon defining the time duration for which the optimized sequence and schedule is generated, given at least one constraint and a capacity definition, the capacity definition defining the number of units that can be produced in a defined time period, the job comprising at least one unit to be produced, the system comprising:
a. means for generating at least one generic job object in response to a job definition, the job definition comprising at least one attribute describing the job;
b. means for generating at least one generic constraint object in response to a constraint definition, the constraint definition comprising a limitation on the production of the job;
c. means for generating at least one generic slot object in the sequencing horizon using the capacity definition, the slot object comprising at least one attribute uniquely identifying a slot, the slot comprising a capacity for production of a unit of the job;
d. means for generating a generic parameters object in response to sequencing and scheduling parameters, the parameters definition comprising at least one parameter influencing the method of optimization used for generating the optimized sequence and schedule;
e. means for generating an initial solution using a predefined logic; and
f. means for generating the optimized sequence and schedule by an optimization algorithm, the optimization algorithm using at least one of the generated generic job object, at least one of the generated generic slot object, at least one of the generated generic constraint object, the generated generic parameters object and the generated initial solution.

16. The system according to claim 15, wherein the means for generating a generic job object in response to a job definition comprises at least one of:
a. means for assigning at least one attribute value in the job definition to at least one attribute of the generic job object; and
b. means for calculating at least one complex job attribute of the generic job object using at least one attribute value in the job definition.

17. The system according to claim 15, wherein the means for generating a generic constraint object comprises:
a. means for specifying a constraint type;
b. means for specifying a bin type, wherein the bin type is a time unit in the sequencing horizon;
c. means for specifying at least one attribute kit, the attribute kit indicating the attributes of a unit of production to which the constraint is applicable;
d. means for specifying a priority, the priority defining the importance of the constraint relative to other constraints;
e. means for specifying a penalty severity factor parametrically relating the cost incurred upon a constraint not being satisfied to the extent of violation of the constraint;
f. means for specifying a set of constraint time windows indicative of the time duration during which the constraint is active; and
g. means for specifying a consider flag for allowing disabling of the constraint.

18. The system according to claim 15, wherein the means for generating a generic constraint object comprises means for specifying constraint specific properties associated with the generic constraint object.

19. The system according to claim 18, wherein the means for specifying constraint specific properties comprises at least one of:
a. means for specifying a minimum production quantity;
b. means for specifying a maximum production quantity; and
c. means for specifying an attribute kit value against each attribute kit in the generic constraint object.

20. The system according to claim 15, wherein the means for generating a generic slot object comprises means for assigning a slot identifier for uniquely identifying the slot.

21. The system according to claim 15, wherein the means for generating a generic slot object comprises at least one of:
a. means for assigning a time-based bin identifier for identifying the bin to which the slot belongs;
b. means for assigning a non-time-based bin identifier for identifying the bin to which the slot belongs; and
c. means for assigning a job attribute associated with the slot.

22. The system according to claim 15, wherein the means for generating an initial solution in response to a predefined logic comprises means for generating a random initial solution.

23. The system according to claim 15, wherein the means for generating the initial solution in response to a predefined logic further comprises means for generating an initial solution in response to a logic defined on the job definition.

24. The system according to claim 15, wherein the optimization algorithm uses at least one of a combinatorial optimization method and a search heuristics method for generation of the optimized sequence and schedule.

25. The method according to claim 15, wherein the optimization algorithm uses an optimization methodology from a group consisting of simulated annealing, constraints technology and greedy heuristics.

26. The system according to claim 15, further comprising means for representing the optimized sequence and schedule in the form of a generic solution object to facilitate examination, analysis and manipulation of the optimized sequence and schedule.

27. The system according to claim 26, further comprising means for manipulating the optimized sequence and schedule, the means for manipulating comprising at least one of:
a. means for exchanging a pair of jobs in the optimized sequence and schedule;
b. means for moving one or more jobs in the optimized sequence and schedule to another position;
c. means for adding a job to the optimized sequence and schedule; and
d. means for deleting a job from the optimized sequence and schedule.

28. The system according to claim 27, wherein the means for manipulating further comprises at least one of:
a. means for providing a changed total cost resulting from the manipulations;
b. means for allowing a user to accept or reject the manipulations; and
c. means for allowing a user to rollback previously accepted manipulations.

29. A system for generating an optimized sequence for at least one job, given at least one constraint and a capacity definition, the job comprising a plurality of units to be produced, the system comprising:
a. configurable layer, wherein the configurable layer comprises means for storing at least one generic job object, at least one generic constraint object, at least one generic slot object and a generic parameters object, the generic job object comprising at least one attribute describing the job, the generic constraint object comprising a constraint on the production of the job, the slot object comprising at least one attribute uniquely identifying a slot, the slot comprising a capacity for production of a unit of the job, the generic parameters object comprising at least one parameter influencing the method of optimization used for generating the optimized sequence and schedule; and
b. a core product layer, the core product layer comprising an optimization engine, the optimization engine being used to generate an optimized sequence and
schedule using the generated generic job object, the generated generic slot object and the generated generic constraint object.

30. The system according to claim 29, wherein the configurable layer comprises:
a. configuration data files for customizing the configurable layer according to a specific manufacturing environment; and
b. a database for storing data required for generating the optimized sequence and schedule.

31. The system according to claim 29, wherein the configuration data files comprise
a. input files, the input files being used to input a job definition, a constraint definition, a parameters definition and the capacity definition to the system; and
b. script files, the script files being executed by a parsing engine embedded within the core product layer.

32. The system according to claim 31, wherein the script files comprise:
a. means for configuring workflow of the system, wherein the workflow comprises a plurality of executable actions to be performed within the system;
b. means for configuring an external interface to the system;
c. means for generating a generic job object;
d. means for generating a generic slot object;
e. means for generating a generic constraint object; and
f. means for generating a generic parameters object.

33. The system according to claim 31, wherein the script files comprise means for generating at least one report, the report being used for decision support of the system.

34. The system according to claim 30, wherein the database comprises:
a. means for storing a job definition, a constraint definition, a parameters definition and the capacity definition; and
b. means for storing a data dictionary, the data dictionary being used to facilitate configuration of the job definition, the constraint definition, the parameters definition and the capacity definition.

35. The system according to claim 34, wherein the data dictionary comprises:
a. means for creating at least one database table for storing the job definition, the constraint definition, the parameters definition and the capacity definition; and
b. means for defining a database schema.

36. The system according to claim 29, wherein the core product layer comprises a web application, the web application comprising:
a. means for providing an external interface for accessing the system;
b. means for providing access to a database;
c. means for executing business logic;
d. means for providing access to configuration data files;
e. means for generating graphical user interfaces;
f. means for maintaining a job definition, a constraint definition, a parameters definition and the capacity definition; and
g. means for analysis of the generated optimized sequence and schedule.

37. A computer program product for obtaining an optimized sequence and schedule for production of at least one job in a sequencing horizon, the sequencing horizon defining the time duration for which the optimized sequence and schedule is generated, given at least one constraint and a capacity definition, the capacity definition defining the number of units that can be produced in a defined time period, the job comprising at least one unit to be produced, the computer program product comprising a computer readable medium comprising:
a. program instruction means for generating at least one generic job object in response to a job definition, the job definition comprising at least one attribute describing the job;
b. program instruction means for generating at least one generic constraint object in response to a constraint definition, the constraint definition comprising a limitation on the production of the job;
c. program instruction means for generating at least one generic slot object in the sequencing horizon using the capacity definition, the slot object comprising at least one attribute uniquely identifying a slot, the slot comprising a capacity for production of a unit of the job;
d. program instruction means for generating a generic parameters object in response to sequencing and scheduling parameters, the parameters definition comprising at least one parameter influencing the method of optimization used for generating the optimized sequence and schedule;
e. program instruction means for generating an initial solution using a predefined logic; and
f. program instruction means for generating the optimized sequence and schedule by an optimization algorithm, the optimization algorithm using at least one of the generated generic job object, at least one of the generated generic slot object, at least one of the generated generic constraint object, the generated generic parameters object and the generated initial solution.

38. The computer program product according to claim 37, wherein the program instruction means for generating a generic job object in response to a job definition comprises at least one of:
a. program instruction means for assigning at least one attribute value in the job definition to at least one attribute of the generic job object; and
b. program instruction means for calculating at least one complex job attribute of the generic job object using at least one attribute value in the job definition.

39. The computer program product according to claim 37, wherein the program instruction means for generating a generic constraint object comprises:
a. program instruction means for specifying a constraint type;
b. program instruction means for specifying a bin type, wherein the bin type is a time unit in the sequencing horizon;
c. program instruction means for specifying at least one attribute kit, the attribute kit indicating the attributes of a job to which the constraint is applicable;
d. program instruction means for specifying a priority, the priority defining the importance of the constraint relative to other constraints;
e. program instruction means for specifying a penalty severity factor parametrically relating the cost incurred upon a constraint not being satisfied to the extent of violation of the constraint;
f. program instruction means for specifying a set of constraint time windows indicative of the time duration during which the constraint is active; and
g. program instruction means for specifying a consider flag for allowing disabling of the constraint.

40. The computer program product according to claim 37, wherein the program instruction means for generating a generic constraint object comprises program instruction means for specifying constraint specific properties associated with a generic constraint object.

41. The computer program product according to claim 40, wherein the program instruction means for specifying constraint specific properties comprises at least one of:
a. program instruction means for specifying a minimum production quantity;
b. program instruction means for specifying a maximum production quantity; and
c. program instruction means for specifying an attribute kit value against each attribute kit in the generic constraint object.

42. The computer program product according to claim 37, wherein the program instruction means for generating a generic slot object comprises program instruction means for assigning a slot identifier for uniquely identifying the slot.

43. The computer program product according to claim 37, wherein the program instruction means for generating a generic slot object comprises at least one of:
a. program instruction means for assigning a time-based bin identifier for identifying the bin to which the slot belongs;
b. program instruction means for assigning a non-time-based bin identifier for identifying the bin to which the slot belongs; and
c. program instruction means for assigning a job attribute associated with the slot.

44. The computer program product according to claim 37, wherein the program instruction means for generating an initial solution in response to a predefined logic comprises program instruction means for generating a random initial solution.

45. The computer program product according to claim 37, wherein the program instruction means for generating the initial solution in response to a predefined logic comprises program instruction means for generating an initial solution in response to a logic defined on the job definition;

46. The computer program product according to claim 37, wherein the optimization algorithm uses at least one of a combinatorial optimization method and a search heuristics method for generation of the optimized sequence and schedule.

47. The computer program product according to claim 37, wherein the optimization algorithm uses an optimization methodology from a group consisting of simulated annealing, constraints technology and greedy heuristics.

48. The computer program product according to claim 37 further comprising program instruction means for representing the optimized sequence and schedule in the form of a generic solution object to facilitate examination, analysis and manipulation of the optimized sequence and schedule.

49. The computer program product according to claim 48 further comprising program instruction means for manipulating the optimized sequence and schedule, the program instruction means for manipulating comprising at least one of:
a. program instruction means for exchanging a pair of jobs in the optimized sequence and schedule;
b. program instruction means for moving one or more jobs in the optimized sequence and schedule to another position;
c. program instruction means for adding a job to the optimized sequence and schedule; and
d. program instruction means for deleting a job from the optimized sequence and schedule.

50. The computer program product according to claim 49, wherein the program instruction means for manipulating further comprises at least one of:
a. program instruction means for providing a changed total cost resulting from the manipulations using the defined constraints;
b. program instruction means for allowing the user to accept or reject the manipulations; and
c. program instruction means for allowing the user to rollback previously accepted manipulations.
